(19) United States
(12) Patent Application Publication
(10) Pub. No.: US 2025/0356407 A1
(43) Pub. Date: Nov. 20, 2025

(54) SYSTEMS AND METHODS FOR IN-PERSON INTERACTIVE SHOPPING

(71) Applicant: JPMORGAN CHASE BANK, N.A., New York, NY (US)

(72) Inventors: Samuel STEGALL, Houston, TX (US); Rangarao SAMINDLA, Frisco, TX (US); Samuel OWENS, Dallas, TX (US); Jimmy ZHANG, Frisco, TX (US); Marigrace SEATON, Los Angeles, CA (US); Sherwin MASSOUDIAN, Lewisville, TX (US); Diane CALDERON ORTEGA, Mansfield, TX (US); Rahul VUTUKURU, San Antonio, TX (US); Riddhi GUNASEKARAN, Frisco, TX (US); Adarsh BALUSU, Dallas, TX (US); Adrian BUTLER, JR., Plano, TX (US); Sarah SADIQ, Frisco, TX (US); Sri BASKARAN, McKinney, TX (US); Mizan MIAH, Wilmington, DE (US); Akmsaleh SULTAN, Richardson, TX (US)

(21) Appl. No.: 19/210,251

(22) Filed: May 16, 2025

Related U.S. Application Data
(60) Provisional application No. 63/648,544, filed on May 16, 2024.

(51) Int. Cl. G06Q 30/0601; G06Q 30/0207; G06V 20/40; G06V 20/52; G06V 40/16

(52) U.S. Cl. CPC G06Q 30/0631; G06Q 30/0223; G06Q 30/0224; G06Q 30/0639; G06V 20/52; G06V 40/172; G06V 20/40

(57) ABSTRACT

Systems and methods for in-person interactive shopping are disclosed. In one embodiment, a method may include: (1) identifying, by a computer program, a customer that is present in an area; (2) monitoring, by the computer program, a location of the customer in the area; (3) receiving, by the computer program and from a sensor near the location of the customer, a customer movement associated with removing an item from a shelf; (4) identifying, by the computer program, the item; (5) predicting, by the computer program, that the customer has removed the item from the shelf; (6) adding, by the computer program, the item to a virtual shopping cart for the customer; (7) decreasing, by the computer program, a stored inventory of the item; and (8) charging, by the computer program, the customer for the item.

### RELATED APPLICATIONS

This application claims priority to, and the benefit of, U.S. Provisional Patent Application Ser. No. 63/648,544, filed May 16, 2024, the disclosure of which is hereby incorporated, by reference, in its entirety.

### BACKGROUND OF THE INVENTION

### 1. Field of the Invention

Embodiments relate to systems and methods for in-person interactive shopping.

### 2. Description of the Related Art

In-person shopping lacks the experience that is often provided when shopping on-line. For example, the customer is generally unaware of shopping opportunities associated with the items added to the customer's shopping cart until the items are scanned as part of the checkout process. Thus, opportunities to bundle items for a discount, or to select items with a lower price, are often missed.

### SUMMARY OF THE INVENTION

Systems and methods for in-person interactive shopping are disclosed. In one embodiment, a method may include: (1) identifying, by a computer program, a customer that is present in an area; (2) monitoring, by the computer program, a location of the customer in the area; (3) receiving, by the computer program and from a sensor near the location of the customer, a customer movement associated with removing an item from a shelf; (4) identifying, by the computer program, the item; (5) predicting, by the computer program, that the customer has removed the item from the shelf; (6) adding, by the computer program, the item to a virtual shopping cart for the customer; (7) decreasing, by the computer program, a stored inventory of the item; and (8) charging, by the computer program, the customer for the item.

In one embodiment, the method may also include: predicting, by the computer program, a complementary item to the item; and suggesting, by the computer program, the complementary item to an electronic device associated with the customer.

In one embodiment, the computer program predicts the complementary item using a machine learning engine that may be trained on historical purchase data.

In one embodiment, the computer program predicts the complementary item based on a recipe including the item.

In one embodiment, the computer program predicts the complementary item based on an inventory of the complementary item.

In one embodiment, the method may also include: applying, by the computer program, a discount in response predicting that the customer has removed the complementary item from a second shelf.

In one embodiment, the customer may be identified based on a presence of a customer electronic device.

In one embodiment, the customer may be identified using facial recognition.

In one embodiment, the sensor may include a ultrawide band (UWB) sensor, and the customer may be associated with a wearable UWB-enabled device.

In one embodiment, the sensor may include an infrared camera.

According to another embodiment, a system may include: a plurality of shelves in an area, each shelf with a plurality of items; a plurality of sensors in the area; and a computer program executed by an electronic device in communication with the plurality of sensors. The computer program identifies a customer that is present in the area; the computer program monitors a location of the customer in the area; one of the plurality of sensors detects a customer movement near the location; the computer program receives the customer movement from the sensor; the computer program identifies the customer movement as being associated with removing one of the items from a shelf; the computer program identifies the item; the computer program predicts that the customer has removed the item from the shelf; the computer program adds the item to a virtual shopping cart for the customer; the computer program decreases a stored inventory of the item; and the computer program charges the customer for the item.

In one embodiment, the computer program predicts a complementary item to the item and suggests the complementary item to an electronic device associated with the customer.

In one embodiment, the computer program predicts the complementary item using a machine learning engine that may be trained on historical purchase data.

In one embodiment, the computer program predicts the complementary item based on a recipe including the item.

In one embodiment, the computer program predicts the complementary item based on an inventory of the complementary item.

In one embodiment, the computer program applies a discount in response predicting that the customer has removed the complementary item from a second shelf.

In one embodiment, the customer may be identified based on a presence of a customer electronic device.

In one embodiment, the customer may be identified using facial recognition.

In one embodiment, the sensor may include a ultrawide band (UWB) sensor, and the customer may be associated with a wearable UWB-enabled device.

In one embodiment, the sensor may include an infrared camera.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for in-person interactive shopping according to an embodiment;

FIGS. 2A and 2B illustrate a method system for in-person interactive shopping according to an embodiment;

FIG. 3 illustrates an exemplary display of a customer mobile electronic device according to an embodiment;

FIG. 4 depicts an exemplary computing system for implementing aspects of the present disclosure.

### DETAILED DESCRIPTION OF PREFERRED EMBODIMENTS

Systems and methods for in-person interactive shopping are disclosed.

Ultra-wideband (UWB) is a type of radio connection that allows compatible devices to communicate with each other via a broadcast-to-listener model. In conventional practice, UWB is a connection interface that can be leveraged on smartphone platforms to send messages and trigger functionalities from a broadcasting source with an effective radius of 25 meters. This technology allows for proximity-based functionality, where certain actions can be triggered on an individual's phone when he or she walks within range of a broadcasting source.

Currently, there are many technologies that can be employed to communicate between smartphones with respect to proximity, such as cellular connectivity, NFC, WiFi, and geolocation with GPS. All these methods present different challenges, however. For example, NFC has an effective transmission range of several centimeters between devices. WiFi requires two devices to be on the same network, and geolocation with GPS must be coordinated with internet connectivity and background services to poll device location with respect to other devices, via methods such as geo-fencing. These technologies are useful but do not adequately address the challenge of connecting two devices with a range greater than NFC with low complexity. UWB fills this niche since it effectively transmits data within a 25-meter radius, allowing for proximity-based communication without a large degree of complexity, as one may find when implementing geo-fencing.

In embodiments, UWB may be used to send notifications to customer smartphones when they walk into a store, such as notifications that inform the customer of exclusive discounts that may be available. These offers may be based on the customer being a customer of a credit card issuer, having a loyalty account with the merchant, etc. To do this, two mobile applications may be used to leverage UWB. The first app may use UWB to broadcast messages, offers, discounts, etc. to customer mobile devices. The second app may listen for a signal emitted by the first app. When a device running the second app walks within range of a device broadcasting discounts, the second app will query an API to pull the discount information and present it to the customer in the form of a notification. When the user opens the notification, the customer will be prompted to activate the offer.

In embodiments, as shoppers add items to their cart, the system, through a wearable device such as a UWB-enabled smart watch or a dedicated UWB wristband, triggers notifications on their smartphones about potential combination deals involving the selected item and complementary products.

This approach not only offers customers immediate savings through tailored discounts, but also guides their purchasing decisions, enriching their shopping journey.

In one embodiment, the customer location in the store may be tracked by, for example, video camera(s). When the customer reaches for an item, one or more sensors may sense the movement and provide the data to a machine learning model. The machine learning model may predict whether the customer has removed the item from the shelf and placed the item in a physical shopping cart. The item may be identified from the location of the customer in the store and the movements detected by the sensor(s).

For retailers, embodiments provide invaluable insights into consumer behavior, facilitating optimized store layouts and targeted promotions. Thus, embodiments provide a symbiotic enhancement of customer experience and retail management.

Embodiments may also facilitate real-time inventory tracking, as the inventory for an item may be reduced as soon as it is removed from the shelf. This may facilitate quicker restocking, as an alert may be generated with the on-shelf inventory falls below a threshold. This may result in the shelf being restocked much faster that without this technology and improves the operation of the inventory management system.

In one embodiment, video cameras may be used to track a customer. The video cameras may leverage optical camera recognition to identify and track customers as they move throughout a store.

In one embodiment, infrared cameras or similar devices may also be used in conjunction with UWB devices, or instead of UWB devices, to detect when an item is removed from a shelf and put in a customer's shopping cart. For example, an infrared camera on a shelf may track heat to determine when an item is removed or added to the shelf. Thus, the customer's virtual cart may be updated without using a UWB-enabled smart watch or a dedicated UWB wristband.

In embodiments, customers may be presented with discounts and real-time notifications that may enhance the customer's shopping experience, leading to higher customer satisfaction and foster long-term loyalty; may promote specific combo deals encourages the purchase of targeted items, boosting sales and ensuring more effective inventory turnover for retailers; may provide an analysis of shopper behavior and item combinations that allows for optimized store layouts and smarter inventory management, resulting in a more efficient shopping environment; may offer dynamic marketing opportunities, enabling retailers to introduce and promote new or underperforming products directly to consumers at the point of decision, thereby increasing product visibility and trial rates; etc.

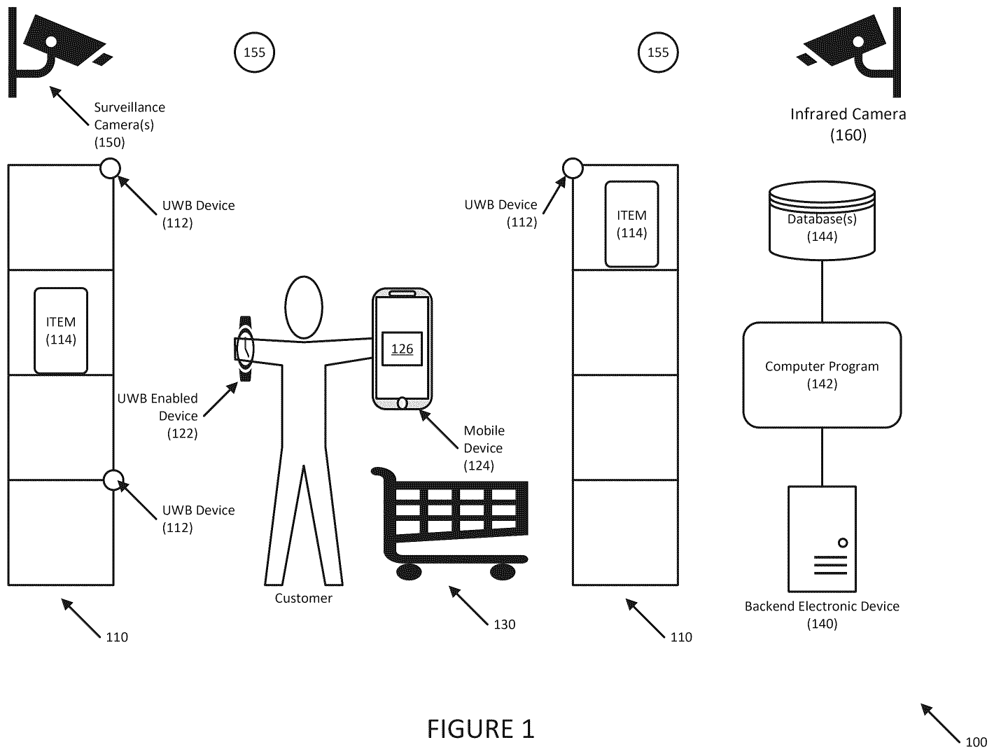

Referring to FIG. 1, a system for in-person interactive shopping is disclosed according to an embodiment. In system 100, a customer may shop at an area, such as a merchant location, that may include a plurality of shelves 110 or other areas where items 114 may be displayed for sale. The customer may wear UWB-enabled device 122, such as a smart watch, a wristband, etc., and the shelves 110 or certain areas of the store may be provided with UWB sensing devices 112. UWB sensing devices 112 may be provided at any suitable location as is necessary and/or desired.

The customer may also carry customer mobile device 124, such as a smartphone. Customer mobile device 124 may also be UWB-enabled and may be tracked by UWB sensing devices 112.

Customer mobile device 124 may execute one or more applications 126, such as a shopping application.

UWB-enabled device 122 may be tracked by one or more UWB sensing devices 112. As the customer reaches to secure item 114 to put in shopping cart 130, computer program 142 executed by backend electronic device 140 may receive information from one or more UWB sensor (e.g., the direction and distances between UWB sensing devices 112 and UWB-enabled device 122) to determine a location of UWB-enabled device 122. Computer program 142 may also identify item 114 and may determine whether item 114 has been removed from shelf 110. In one embodiment, a trained machine learning engine may be used to predict whether the motion of UWB-enabled device 122 is likely to be associated with picking up item 114 and putting it in shopping cart 130.

One or more databases 144 may be provided. For example, database 144 may store location information for items 114, such as where in the store items 114 are located (e.g., an identification of shelf 110, etc.). Computer program 142 may use the information from the sensors and from database 144 to identify item 114 that the customer is placing in cart 130.

Database 144 may also store inventory information for items 114.

Database 144 may also store information on promotions for items 114, historical purchase data for the customer and other customers, recipes, and combinations, etc. The information may be used to suggest additional items to the customer to purchase.

Backend electronic device 140 may be a server (e.g., physical and/or cloud-based), a computer etc.

In one embodiment, a single UWB sensing device 112 may be used; in another embodiment, a plurality of UWB sensing devices 112 may be used, and their data may be used to identify the location of UWB-enabled device 122 using triangulation or similar.

In embodiments, other location-sensing technologies may be used with data from UWB sensing devices 112 to provide additional data. For example, Global Positioning Systems, WiFi, Bluetooth and Bluetooth Low Energy, 5G, radio frequency tags, etc. may be used with UWB to determine the location of the customer and to track the customer's activity. For example, beacons 155, which may be Bluetooth, Bluetooth Low Energy, WiFi, etc. may be used to detect mobile device 124 and/or application 126.

In one embodiment, a network of beacons 155 may be used throughout the store.

System 100 may further include one or more surveillance cameras 150. In one embodiment, cameras 150 may monitor the movement of customers throughout the store and may be used to identify and track multiple customers. For example, customers using application 126 or are otherwise registered may be identified and tracked according to their username, registered name, or other identifier, and customer that are not using application 126 or are otherwise unknow may be tracked as guests.

System 100 may also include one or more infrared cameras 160 or similar devices. Infrared cameras 160 may monitor heat from a customer. In one embodiment, infrared cameras 160 may be placed on each shelf 110 and may use detected heat to determine when item 114 is removed or added to shelf 110.

In one embodiment, a combination of data from UWB device 112, surveillance camera(s) 150, and infrared cameras 160 may be used to predict whether item 114 has been physically added to the customer's shopping cart 130.

Once item 114 is predicted to be put in shopping cart 130, computer program 142, which may be executed by backend electronic device 140, may identify and send recommendations, offers, etc. to UWB-enabled device 122 and/or customer's mobile device 124 (e.g., via application 126).

Computer program 142 may use a trained machine learning engine to predict a pattern of purchases based on what other customers purchasing the same item(s) end up purchasing (e.g., ingredients for a meal). Based on the prediction, computer program 142 may suggest additional items to purchase, and may provide a location for the items (e.g., “It looks like you are going to make cookies. Sugar is in Aisle 10 on the left side on the bottom shelf.”). Computer program 142 may also offer discounts for certain brands that may have an excess in stock.

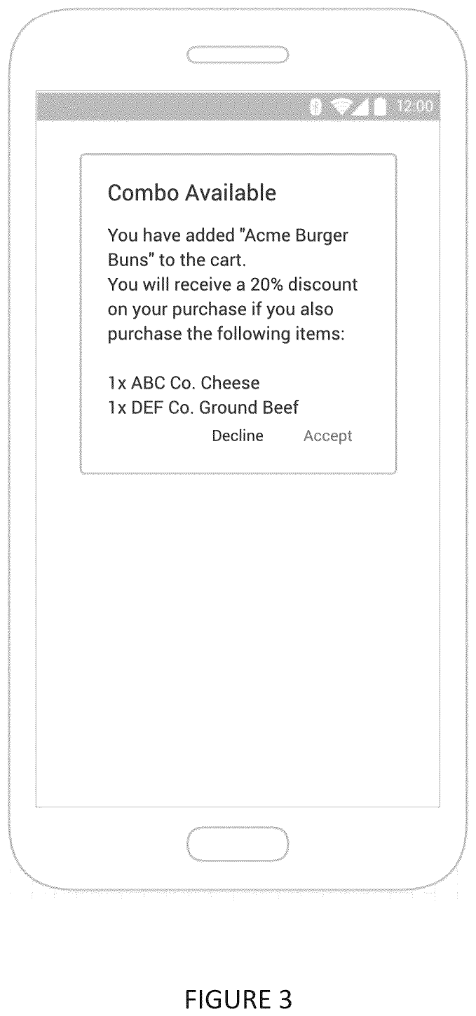

In another embodiment, computer program 142 may provide suggested alternatives, may offer a discount to bundle items together, etc. An example of such a message is provided in FIG. 3.

In one embodiment, the computer program may also update the merchant's inventory based on the item being removed from the shelf. In one embodiment, the backend computer program may also predict the likelihood that the customer will purchase the item once it is removed from the shelf instead of returning it to the shelf, leaving it somewhere else in the store, etc.

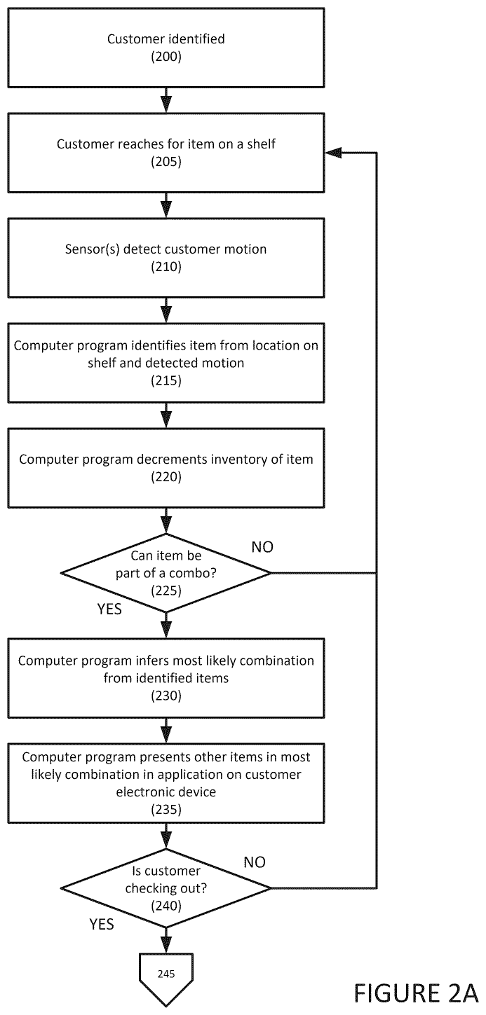

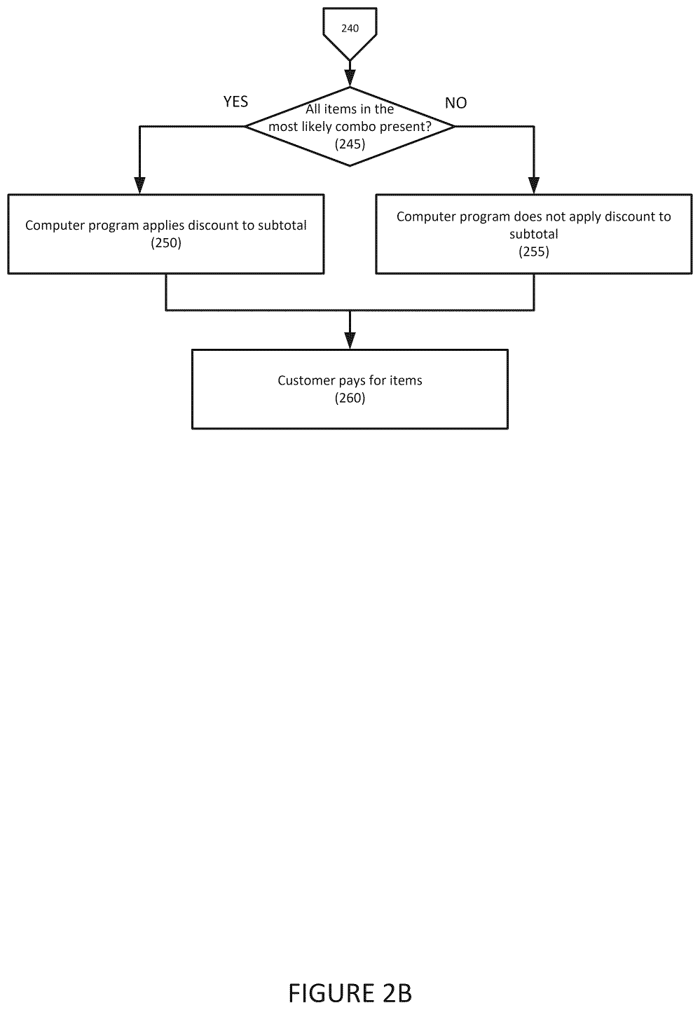

Referring to FIGS. 2A and 2B, a method for in-person interactive shopping is disclosed according to an embodiment.

In step 200, a customer in an area, such as a merchant location, may be identified. For example, the customer may be identified by a surveillance camera as the customer enters the area and moves about the area. In one embodiment, the customer may be identified using facial recognition or similar, and the data from the surveillance cameras may be used to track the customer as the customer moves about the area.

In one embodiment, the customer's electronic device may be identified by one or more beacons, such as Bluetooth/Bluetooth Low Energy beacons, WiFi beacons, 5G beacons, etc. In one embodiment, if the customer is using a shopping application provided by the merchant, or a known/registered mobile device, the customer may be identified and tracked using that identification. A combination of data from the surveillance cameras and the beacons may be used to track a customer as the customer moves throughout the area, and to track items put into the customer's physical shopping cart as a virtual shopping cart.

In one embodiment, the data from the surveillance cameras may be used to establish a mapping of the customer in a three-dimensional space based on the customer's movement within the video data.

In step 205, the customer may reach for item on a shelf. The customer may be wearing a UWB-enabled device.

In one embodiment, the location of the customer, which may be based on data received from surveillance cameras and beacons, may be used to identify the shelf that the customer is interacting with.

In step 210, one or more sensors may detect the customer movement. For example, one or more UWB sensors may detect the movement of the UWB enabled device relative to the shelf.

In one embodiment, data from an infrared camera, such as heat data, may be used to monitor the customer's movements and interaction with the shelf. For example, one or more infrared cameras may identify when a customer reaches for an item on a shelf based on the body heat detected from the customer's hand.

The data from the infrared cameras may be used with data from the UWB sensors, or in place of the UWB sensors if the UWB sensors are not present or available.

In step 215, a computer program may identity the item from the customer location, the location on shelf, and the detected customer motion. The computer program may add the item to the customer's virtual shopping cart.

In step 220, the computer program may decrease the inventory of the items.

In step 225, the computer program may determine whether item can be part of a combination with other items, or if there are complementary items to suggest to the customer.

In step 230, if the item can be part of a combination, or if there are other complementary items to suggest, the computer program may predict the most likely item(s) to suggest to the customer. In one embodiment, the computer program may use a trained machine learning engine to identify the complementary item(s). The prediction may be based on historical purchase information for the customer and/or other customers, recipes, etc.

In step 235, the computer program may present the complementary item(s) to an application on a customer electronic device. The computer program may offer a discount to purchase the complementary items.

In step 240, if the customer is checking out, in step 245,

In step 245, the computer program may determine if the suggested items are present. If they are, in step 250, the computer program may apply the discount. If they are not, in step 255, the computer program may not apply the discount.

In step 260, the customer may pay for the items.

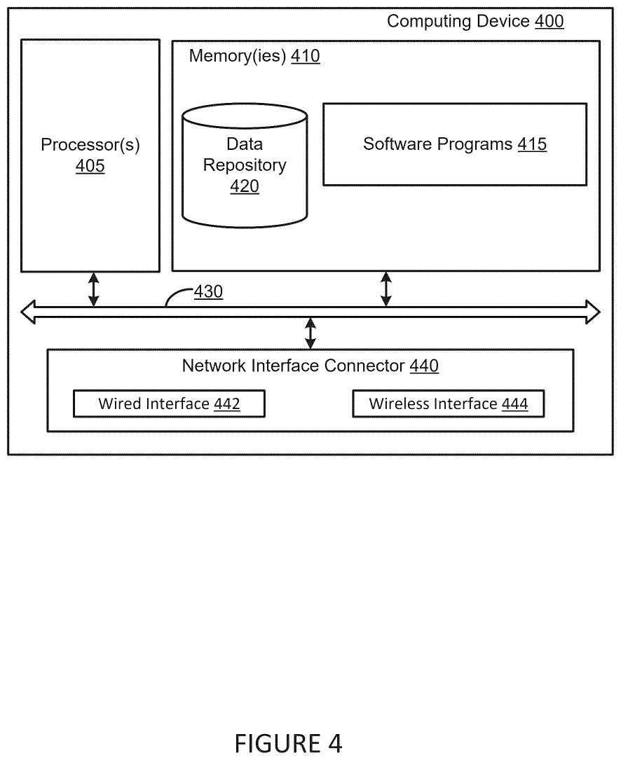

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
identifying, by a computer program, a customer that is present in an area;
monitoring, by the computer program, a location of the customer in the area;
receiving, by the computer program and from a sensor near the location of the customer, a customer movement associated with removing an item from a shelf;
identifying, by the computer program, the item;
predicting, by the computer program, that the customer has removed the item from the shelf;
adding, by the computer program, the item to a virtual shopping cart for the customer;
decreasing, by the computer program, a stored inventory of the item; and
charging, by the computer program, the customer for the item.

2. The method of claim 1, further comprising:
predicting, by the computer program, a complementary item to the item; and
suggesting, by the computer program, the complementary item to an electronic device associated with the customer.

3. The method of claim 2, wherein the computer program predicts the complementary item using a machine learning engine that is trained on historical purchase data.

4. The method of claim 2, wherein the computer program predicts the complementary item based on a recipe including the item.

5. The method of claim 2, wherein the computer program predicts the complementary item based on an inventory of the complementary item.

6. The method of claim 2, further comprising:
applying, by the computer program, a discount in response predicting that the customer has removed the complementary item from a second shelf.

7. The method of claim 1, wherein the customer is identified based on a presence of a customer electronic device.

8. The method of claim 1, wherein the customer is identified using facial recognition.

9. The method of claim 1, wherein the sensor comprises a ultrawide band (UWB) sensor, and the customer is associated with a wearable UWB-enabled device.

10. The method of claim 1, wherein the sensor comprises an infrared camera.

11. A system, comprising:
a plurality of shelves in an area, each shelf with a plurality of items;
a plurality of sensors in the area; and
a computer program executed by an electronic device in communication with the plurality of sensors;
wherein:
the computer program identifies a customer that is present in the area;
the computer program monitors a location of the customer in the area;
one of the plurality of sensors detects a customer movement near the location;
the computer program receives the customer movement from the sensor;
the computer program identifies the customer movement as being associated with removing one of the items from a shelf;
the computer program identifies the item;
the computer program predicts that the customer has removed the item from the shelf;
the computer program adds the item to a virtual shopping cart for the customer;
the computer program decreases a stored inventory of the item; and
the computer program charges the customer for the item.

12. The system of claim 11, wherein the computer program predicts a complementary item to the item and suggests the complementary item to an electronic device associated with the customer.

13. The system of claim 12, wherein the computer program predicts the complementary item using a machine learning engine that is trained on historical purchase data.

14. The system of claim 12, wherein the computer program predicts the complementary item based on a recipe including the item.

15. The system of claim 12, wherein the computer program predicts the complementary item based on an inventory of the complementary item.

16. The system of claim 12, wherein the computer program applies a discount in response predicting that the customer has removed the complementary item from a second shelf.

17. The system of claim 11, wherein the customer is identified based on a presence of a customer electronic device.

18. The system of claim 11, wherein the customer is identified using facial recognition.

19. The system of claim 11, wherein the sensor comprises a ultrawide band (UWB) sensor, and the customer is associated with a wearable UWB-enabled device.

20. The system of claim 12, wherein the sensor comprises an infrared camera.
